(19) United States
(12) Patent Application Publication
(10) Pub. No.: US 2024/0269970 A1
(43) Pub. Date: Aug. 15, 2024

(54) MULTILAYER FILMS SUITABLE FOR VERTICAL FORM FILLING AND SEALING

(71) Applicant: SABIC GLOBAL TECHNOLOGIES B.V., BERGEN OP ZOOM (NL)

(72) Inventors: Mohamed Ouddane, Riyadh (SA); Riyadh Al Homoud, Riyadh (SA); Muneeb Bappankad, Riyadh (SA)

(21) Appl. No.: 18/564,887

(22) PCT Filed: May 23, 2022
(86) PCT No.: PCT/EP2022/063838

§ 371 Date: Nov. 28, 2023

(30) Foreign Application Priority Data
Jun. 9, 2021 (EP) 21178418.6

(51) Int. Cl. B32B 27/08; B32B 27/18; B32B 27/32; B65B 1/00; B65B 43/54; B65D 65/40

(52) U.S. Cl. CPC B32B 27/08; B32B 27/18; B32B 27/32; B65B 1/00; B65B 43/54; B65D 65/40; B32B 2250/03; B32B 2250/242; B32B 2250/40; B32B 2270/00; B32B 2307/30; B32B 2307/54; B32B 2307/5825; B32B 2307/72; B32B 2307/7376; B32B 2307/746; B32B 2439/46

(57) ABSTRACT

A multilayer film, which is suitable for producing packaged material in a vertical form filling and sealing packaging line, includes: a first skin layer and a second skin layer, each of which independently includes: ≥30.0 wt % and ≤45.0 wt % of an ethylene polymer having a density ≥918 kg/m³ and ≤930 kg/m³; and ≥55.0 wt. % and ≤70.0 wt. % of a first ethylene alpha-olefin copolymer having a density ≥900 kg/m³ and ≤910 kg/m³; and a core layer positioned between the first and second skin layers, where the core layer includes: ≥5.0 wt. % and ≤25.0 wt. % of the ethylene polymer, ≥25.0 wt. % and ≤70.0 wt. % of the first ethylene alpha-olefin copolymer; and ≥25.0 wt. % and ≤50.0 wt. % of a second ethylene alpha-olefin copolymer having a density ≥850 kg/m³ and ≤900 kg/m³.

### FIELD OF INVENTION

The invention relates to the field of polyethylene based multilayer films, which are suitable for producing packaged products in a vertical form filling and sealing (VFFS) line.

### BACKGROUND

Vertical form fill sealing (VFFS) is an automatic assembly line product packaging process, which finds application in packaging products in a wide range of industries ranging from packaging rubber pellets to packaging food and beverage items. The VFFS process is a versatile process for packaging both solid and liquid contents and offers not only fast and efficient system for packaging but also consistency in packaging, with each package having exactly the same amount of product in it. Typically, the VFFS process involves the formation of plastic bags out of a flat roll of plastic film, and simultaneously these bags are filled with a product and subsequently the filled bags are sealed to obtain the final packaged product. However, the plastic bag used in a VFFS production line must have high stiffness (high elastic modulus) so that the plastic bag resists any tendency of deformation once a product is filled in the bag. The prevention of deformation is crucial, as any excessive deformation would cause the bag to be out of shape, which in turn would prevent the proper sealing and closing of the bag once the product is filled resulting in leakage or damage to the product. In addition, high stiffness is also beneficial for transportation of the packaged material, where shape and structural integrity of the packaged material will help prevent damage to the packaged product.

On the other hand in certain industries, the multilayer films used for forming the plastic bag in the VFFS line must meet certain processing characteristics. For example, in the rubber industry, packaging bags made of such multi-layer films, are widely used for packaging rubber pellets. Typically at the compounding facility, the rubber pellets are compounded by feeding the packaged rubber pellet directly into a kneader/compounder without removing the packaging bag. The ability to compound the rubber pellets without removing the plastic bag provides compounders improved process efficiency and reduced operating expenses. However, it has been observed by industry practitioners, that in certain instances, the plastic bag or the multi-layer film has material characteristics, which is incompatible with the rubber melt during compounding, resulting in the plastic bag/film remaining intact as an undispersed foreign matter in the rubber melt, resulting in defects in the final rubber product such as a “fish-eye” defect. Such defects reduce aesthetic appeal of the final rubber products and result in products, which may not match to customer specifications.

Thus, one of the key requirements of a film and the resulting plastic bag formed from such a film is its compatibility with the rubber melt. In other words, the multi-layer film should have sufficient melting point temperature which would cause the plastic bag/film to blend with the rubber melt under conditions of compounding while ensuring that the plastic bag formed in the VFFS line can be used for packaging hot rubber pellets in the production line.

The European granted patent EP0742248 B1, describes a film based on ethylene·α-olefin copolymer suitable for lapping the rubber bale. The granted US granted patent, U.S. Pat. No. 5,120,787 (Drasner) discloses a method of compounding a rubber by using a bag/liner prepared from an ethylene/vinyl acetate (EVA) copolymer, where the bag/liner is directly compounded with the rubber material. However, such patent publications do not specifically describe the requirements of using a film suitable in a VFFS line while also retaining the desired processing characteristics. The PCT patent PCT/EP2020/085419, describes a film suitable for wrapping for rubber bale using horizontal form filling. However, the requirements of elastic modulus as required for horizontal form filling is not as stringent as that for a vertical form fill sealing and such film described in the PCT application will not in general be suitable for VFFS production line.

Therefore, it is an objective of the present invention to provide a multilayer film suitable for use in a vertical form filling and sealing (VFFS) line having one or more benefits of (i) high stiffness (or high elastic modulus) and mechanical property and (ii) suitable compatibility with a rubber melt.

### DESCRIPTION

Accordingly, one or more of the objectives of the present invention is achieved by a multi-layer film comprising:
a. a first skin layer and a second skin layer, wherein each of the first skin layer and the second skin layer independently comprises or consists of:
   ≥30.0 wt. % and ≤45.0 wt. %, preferably ≥35.0 wt. % and ≤45.0 wt. %, of an ethylene polymer, with regard to the total weight of the skin layer; wherein the ethylene polymer has a density of ≥918 kg/m³ and ≤940 kg/m³, preferably ≥920 kg/m³ and ≤930 kg/m³, when determined in accordance with ASTM D792 (2008);
   ≥55.0 wt. % and ≤70.0 wt. %, preferably ≥55.0 wt. % and ≤65.0 wt. %, of a first ethylene alpha-olefin copolymer; wherein the first ethylene alpha-olefin copolymer has a density >900 kg/m³ and ≤915 kg/m³, preferably ≥905 kg/m³ and ≤910 kg/m³ as determined in accordance with ASTM D792 (2008); and
b. a core layer, positioned between the first skin layer and the second skin layer, wherein the core layer comprises or consists of:
   ≥5.0 wt. % and ≤25.0 wt. %, preferably ≥5.0 wt. % and ≤20.0 wt. %, of the ethylene polymer, with regard to the total weight of the core layer;
   ≥25.0 wt. % and ≤70.0 wt. %, preferably ≥40.0 wt. % and ≤60.0 wt. %, of the first ethylene alpha-olefin copolymer, with regard to the total weight of the core layer; and
   ≥25.0 wt. % and ≤50.0 wt. %, preferably ≥25.0 wt. % and ≤35.0 wt. %, of a second ethylene alpha-olefin copolymer; wherein the second ethylene alpha-olefin copolymer has a density ≥850 kg/m³ and ≤900 kg/m³, preferably ≥860 kg/m³ and ≤890 kg/m³, more preferably ≥865 kg/m³ and ≤885 kg/m³, even more preferably ≥865 kg/m³ and ≤875 kg/m³, as determined in accordance with ASTM D792 (2008).

Advantageously, the multilayer film of the present invention has excellent stiffness rendering such films suitable for use in VFFS packaging lines. The multilayer film further has a suitable melting point temperature, which enables the multilayer film or a packaging bag made from such a film, to be compatible with a polymer or a rubber melt during compounding. In addition, the multilayer film has an excellent set of mechanical properties such as tear strength, and tensile elongation, which enable the multilayer film to be used in packaging products in a VFFS production line and for transport and storage of packaged goods.

The expression “skin layer” as used throughout this disclosure means the outermost layers of a multilayer film. The expression “core layer” as used throughout this disclosure means the innermost layer in a multilayer film, positioned between two skin layers. The expression “rubber material” as used in this disclosure means ethylene propylene diene monomer (EPDM) rubber pellets.

The multilayer film may for example comprise a suitable proportion of ethylene polymer, the first ethylene alpha-olefin copolymer and the second ethylene alpha-olefin copolymer, which are distributed across the skin layers and the core layer of the multilayer film. The multilayer film may for example comprise:
≥16.0 wt. % and ≤30.0 wt. %, preferably ≥20.0 wt. % and ≤30.0 wt. %, of the ethylene polymer, with regard to the total weight of the multilayer film;
≥50.0 wt. % and ≤70.0 wt. %, preferably ≥50.0 wt. % and ≤60.0 wt. %, of the first ethylene alpha-olefin copolymer, with regard to the total weight of the multilayer film; and/or
≥14.0 wt. % and ≤25.0 wt. %, preferably ≥20.0 wt. % and ≤25.0 wt. %, of the second ethylene alpha-olefin copolymer, with regard to the total weight of the multilayer film.

In some aspects of the present invention, the ethylene polymer has at least:
a melt flow rate (MFR) ≥0.1 g/10 min and ≤5.0 g/10 min, preferably ≥0.1 g/10 min and ≤1.0 g/10 min, more preferably ≥0.1 g/10 min and ≤0.7 g/10 min, even more preferably ≥0.2 g/10 min and ≤0.7 g/10 min, even more preferably ≥0.2 g/10 min and ≤0.5 g/10 min, as determined at 190°C. at 2.16 kg load in accordance with ASTM D1238; and/or
a melting temperature ≥105°C. and ≤125° C., preferably ≥110° C. and ≤120° C., when determined in accordance with a method based on ASTM D3418-15, using Differential Scanning Calorimetry (DSC) with a first heating and cooling cycle at a temperature between 23° C. to 200° C. and at a heating and a cooling rate of 10° C./min for a 10 mg film sample, using a nitrogen purge gas at flow rate of 50±5 mL/min, followed by a second heating cycle identical to the first heating cycle. The ethylene polymer may for example is a Low Density Polyethylene (LDPE) or an ethylene polymer prepared using free radical polymerization using high pressure polymerization and having the desired attributes of melt flow rate, density and melting temperature.

Preferably, the first ethylene alpha-olefin copolymer has at least any one of:
a melting temperature of ≥85° C. and ≤115° C., preferably ≥88° C. and ≤105° C., using Differential Scanning Calorimetry (DSC) with a first heating and cooling cycle at a temperature between 23° C. to 200° C. and at a heating and a cooling rate of 10° C./min for a 10 mg film sample, using a nitrogen purge gas at flow rate of 50±5 mL/min, followed by a second heating cycle identical to the first heating cycle; and/or
a melt flow rate ≥0.1 g/10 min and ≤5.0 g/10 min, preferably ≥0.5 g/10 min and ≤3.0 g/10 min, preferably ≥0.8 g/10 min and ≤2.0 g/10 min, when determined at 190° C. at 2.16 kg load in accordance with ASTM D1238.

Preferably, the second ethylene alpha-olefin copolymer has at least any one of:
a melting temperature ≥60° C. and ≤85° C., preferably ≥62° C. and ≤65° C., using Differential Scanning Calorimetry (DSC) with a first heating and cooling cycle at a temperature between 23° C. to 200° C. and at a heating and a cooling rate of 10° C./min for a 10 mg film sample, using a nitrogen purge gas at flow rate of 50±5 mL/min, followed by a second heating cycle identical to the first heating cycle; and/or
a melt flow rate ≥0.1 g/10 min and ≤3.0 g/10 min, preferably ≥0.8 g/10 min and ≤2.0 g/10 min, when determined at 190° C. at 2.16 kg load in accordance with ASTM D1238.

The melting temperature of the ethylene polymer, first ethylene alpha-olefin copolymer, and second ethylene alpha-olefin copolymer may be determined using Differential Scanning Calorimetry (DSC) in accordance with the procedure outlined in ASTM D3418-15. The melting temperature as determined using DSC represents the peak melting temperature (Tₘ) observed during the heating/cooling cycling cycles (enthalpy curve) during the DSC measurement.

In some aspects of the invention, the first ethylene alpha-olefin co-polymer and the second ethylene alpha-olefin co-polymer are different, having distinct properties, for example, of density, melt flow rate and units derived from alpha-olefins. For example, the first ethylene alpha-olefin co-polymer may be referred to as a plastomer and the second ethylene alpha-olefin co-polymer may be referred to as an elastomer. The plastomer and the elastomer co-polymers may be distinguished on the basis of the weight quantity of moieties derived from alpha-olefins units, wherein the plastomer has a lower number of units derived from alpha-olefins compared to that of the elastomer.

Preferably, the first ethylene alpha-olefin copolymer comprises moieties derived from (i) ethylene and (ii) ≥2.0 wt. % and ≤25.0 wt. %, preferably ≥10.0 wt. % and ≤20.0 wt. %, of moieties derived from one or more alpha-olefins having 3-12 carbon atoms, with regard to the total weight of the first ethylene alpha-olefin copolymer. Preferably the second ethylene alpha-olefin copolymer comprises moieties derived from (i) ethylene and (ii) ≥30.0 wt. % and ≤45.0 wt. %, preferably ≥35.0 wt. % and ≤40.0 wt. %, of moieties derived from one or more alpha-olefins having 3-12 carbon atoms, with regard to the total weight of the second ethylene alpha-olefin copolymer.

The alpha-olefin having 3-12 carbon atoms may for example be selected from 1-butene, 4-methyl-1-pentene, 1-hexene, and 1-octene. Preferably the alpha-olefin is selected from 1-hexene or 1-octene. The alpha-olefin content may be determined by any suitable technique such as by ¹³C NMR on a Bruker Avance 500 spectrometer equipped with a cryogenically cooled probe head operating at 125° C., whereby samples to be evaluated are dissolved at 130° C. in C₂D₂Cl₄ containing DBPC as stabilizer.

The skin layers may for example contain additives present in the layer. Non limiting examples of such additives include anti-oxidants, UV stabilizers, slipping agent, anti-blocking agent, clarifying agents, pigments, masterbatch compositions and nucleating agents. Preferably, each of the first skin layer and/or the second skin layer independently further comprises one or more additives, present in an amount of ≥1.0 wt. % and ≤6.0 wt. %, preferably ≥1.5 wt. % and ≤5.0 wt. %, with regard to the total weight of the skin layer.

The multilayer film may for example have at least three layers: two skin layers and a core layer positioned between the skin layers. In some aspects of the invention, one or more interim layer may be positioned between each of the skin layers and the core layer. Accordingly, such multilayer films may for example have more than three layers. For example, the interim layers may be an adhesive layer or a structural support layer.

In some aspects of the invention, the multilayer film has a suitable thickness. Preferably, the multilayer film has a thickness of ≥70 μm and ≤200 μm, preferably ≥120 μm and ≤185 μm. The multilayer film is purposely designed to have a suitable proportion of the skin layers and the core layer. Preferably the core layer is present in an amount of ≥65.0 wt. % and ≤80.0 wt. %, preferably ≥70.0 wt. % and ≤80.0 wt. %, with regard to the total weight of the multilayer film. Preferably, each of first skin layer and the second skin layer is present independently in an amount of ≥5.0 wt. % and ≤20.0 wt. %, preferably ≥10.0 wt. % and ≤15.0 wt. %, with regard to the total weight of the multilayer film.

In an aspect of the invention, the inventors surprisingly found that the multilayer film has a suitable balance of mechanical properties and processability properties as evidenced from the properties of elastic modulus, tear resistance and tensile elongation and melting temperature of the multilayer film. Preferably, the multilayer film has:
an elastic modulus of ≥82.0 MPa and ≤150.0 MPa, preferably ≥95.0 MPa and ≤110.0 MPa as determined in accordance with ASTM D882; and/or
a melting temperature of ≥70° C. and ≤110° C., preferably ≥80° C. and ≤105° C., when determined using isothermal hot stage analysis with optical microscopy in accordance with ISO 17025 (2017), using a temperature sweep between ≥85° C. and ≤150° C. and analyzed at each temperature for three minutes and at a heating and a cooling rate of 10° C./min; and/or
a tear resistance in the machine direction (MD) of ≥6.0 (g/μm) and ≤15.0 (g/μm), preferably ≥7.0 (g/μm) and ≤10.0 (g/μm) when determined in accordance with ASTM D1922; and/or
a tensile elongation at yield in the machine direction (MD) of ≥40.0% and ≤70.0%, as determined in accordance with ASTM D882.

The elastic modulus at this level has suitable stiffness and is particularly suitable for using such multilayer films in VFFS packaging line. On the other hand, the melting temperature of the multilayer film may be determined by coupling the hot stage analysis with optical microscopy under conditions of temperature typically used during compounding rubber/polymer material. Accordingly, the melting temperature of the film is determined using hot stage analysis to simulate rubber/polymer compounding conditions while optical microscopy is used to obtain images of the film sample at specific intervals of temperature to visually determine the temperature at which the film sample has completely melted. For example, the film sample may be heated to 85° C. thereafter isothermally maintained at 85° C. for 3 minutes and an image of the film sample is recorded. Subsequently, the film sample may be heated to 90° C. and isothermally maintained at that temperature for 3 minutes to acquire an image of the film sample at 90° C. The same steps may be repeated for each temperature of 95° C., 100° C., 105° C., 110° C., 150° C. and image of the film sample at that specific temperature may be recorded. Accordingly, the melting temperature of the multilayer film is the temperature at which the multilayer film substantially melts such that no trace of film residue is observed by optical microscopy. The expression “substantially” as used herein means that 99 wt. % of the film sample has melted, preferably 99.5% wt. % of the film sample has melted, preferably 100 wt. % of the film sample has melted.

The ethylene polymer and the ethylene alpha-olefin copolymers may be prepared in the manner described in existing publications such as the production of LDPE and LLDPE polymers described in the publication “Handbook of Polyethylene” by Andrew Peacock (2000; Dekker; ISBN 0824795466) at pages 43-66. The ethylene polymer may be prepared using free radical polymerization using high pressure polymerization. The ethylene alpha-olefin copolymer is preferably prepared using Zeigler-Natta catalyst or metallocene catalysts using any one of gas-phase fluidized-bed polymerization, polymerization in solution, or slurry polymerization, preferably the ethylene alpha-olefin copolymer is prepared using metallocene catalysts using gas-phase polymerization. Alternatively, the inventive multilayer film may be prepared using commercially available polymers blended in specific proportions as described in this disclosure.

The multilayer film of the present invention may be prepared in general by any of the known methods known in the art. Multilayer films may be prepared for example by a blown film co-extrusion process, for example as disclosed in “Film Extrusion Manual”, (TAPPI PRESS, 2005, ISBN 1 -59510-075-X, Editor Butler, pages 413-435). For example, in the process of coextrusion, the various resins may be first melted in separate extruders and then brought together in a feed block. The feed block is a series of flow channels which bring the layers together into a uniform stream. From this feed block, this multi-layer material then flows through an adapter and out a film die. The blown film die may be an annular die. The die diameter may be a few centimeters to more than three meters across. The molten plastic is pulled upwards from the die by a pair of nip rolls high above the die (from for example 4 meters to more than 20 meters). Changing the speed of these nip rollers will change the gauge (wall thickness) of the film. Around the die an air-ring may be provided. The air exiting the air-ring cools the film as it travels upwards. In the center of the die there may be an air outlet from which compressed air can be forced into the center of the extruded circular profile, creating a bubble. This expands the extruded circular cross section by some ratio (a multiple of the die diameter). This ratio, called the “blow-up ratio” can be just a few percent to for example more than 300 percent of the original diameter. The nip rolls flatten the bubble into a double layer of film whose width (called the “layflat”) is equal to ½ of the circumference of the bubble. This film may then be spooled or printed on, cut into shapes, and heat sealed into bags or other items.

The process for preparing the multilayer film may for example comprise the steps in this order of:
independently blending three different polymer compositions, each suitable for forming the first skin layer, the core layer and the second skin layer, in a V-blender under temperature conditions not exceeding 40° C. for a time period of about 3 minutes to 5 minutes;
introducing the resulting compositions independently, in a feeder of an extruder capable of extruding each of the compositions independently;
optionally, adding slip and anti-block additives to the composition suitable for forming the skin layers of the inventive multilayer film;
extruding the above compositions using a three co-extrusion line and forming a homogenous extrudate;
processing the extrudate using conventional screws and subsequently forming a melted polymer composition using a feed block; and
conveying the melted polymer composition to a die head section using different types of annular dies and forming a film precursor; and
cooling the film precursor to form the inventive multilayer film.

The multilayer film of the present invention offers a suitable balance of properties which in turn enables the film to be used in a diverse set of articles across various application segments. Preferably the article comprising the multilayer film is selected from a packaging bag, an agricultural film, or a shrink film. Preferably the article is a packaging bag suitable for vertical form filling and sealing (VFFS) packaging line for rubber pellets. In some aspects of the invention, the invention is directed to the use of the multilayer film as a packaging bag suitable for producing packaged material in a vertical form filling and sealing (VFFS) packaging line. In some aspects of the invention, the invention relates to a process for producing a packaged material in a vertical form filling and sealing (VFFS) packaging line, wherein the process comprises the steps in this order of:
providing a packaging bag comprising the multilayer film of the present invention, wherein the packaging bag has a sealed end and an open end such that the longitudinal axis of the bag passes axially through the sealed end and the open end;
clamping the packaging bag at the sealed end, wherein the open end and the close end is co-axial with the longitudinal axis;
introducing a material for packaging into the packaging bag by means of the open end until at least a portion of the packaging bag is filled;
sealing the open end of the packaging bag; and
detaching the clamp and obtaining the packaged material.

Specific examples demonstrating some of the embodiments of the invention are included below. The examples are for illustrative purposes only and are not intended to limit the invention. It should be understood that the embodiments and the aspects disclosed herein are not mutually exclusive and such aspects and embodiments can be combined in any way. Those of ordinary skill in the art will readily recognize parameters that can be changed or modified to yield essentially the same results.

### EXAMPLES

Purpose: To evaluate a polyethylene based multilayer film prepared in accordance with an embodiment of the present invention. The properties of the inventive film was compared with that of films derived from other polyethylene compositions (CF1-CF3 films) and with film (CF4) prepared from ethylene vinyl acetate (EVA).

Material used for the multilayer film: The inventive multilayer film was prepared from the materials listed below:

TABLE 1

| | Polymer Type | Grade Name | Supplier |
|---|---|---|---|
| Ethylene Polymer | Low Density | SABIC ® LDPE | SABIC |
| | Polyethylene | HP0322NN | |
| | (LDPE) | | |
| First Ethylene-alpha | Plastomer (POP) | COHERE ™ 8102L | SABIC |
| olefin co-polymer | | | |
| Second Ethylene-alpha | Elastomer (POE) | COHERE ™ 8170D | SABIC |
| olefin co-polymer | | | |
| Slipping agent Master | NA | PA 83 | Clariant |
| Batch | | | |
| Anti-block agent | NA | PA 80 | Clariant |
| Master Batch | | | |

Specific details of the material grades are provided below:

TABLE 2

| | SABIC ® | | |
|---|---|---|---|
| | LDPE | COHERE ™ | COHERE ™ |
| | HP0322NN | 8102L | 8170D |
| Density (kg/m³) ASTM 792 | 922 | 902 | 868 |
| Melt Flow Rate (MFR) at | 0.33 | 1.0 | 1.0 |
| 190° C. and 2.16 kg | | | |
| ASTM 1238 | | | |
| Melting Temperature (° C.) | 115.6 | 103 | 63 |
| using DSC ASTM D3418-15 | | | |

Process of making the multilayer film: The multilayer films were prepared by following the general steps:
(a) independently blending three different polymer compositions, each suitable for forming the first skin layer, the core layer and the second skin layer respectively in a V-blender under temperature conditions of about 35° C. and for a time period of about 3 minutes;
(b) subsequently, the resulting compositions were introduced independently in a feeder of an extruder that was capable of extruding each of the compositions independently using a three co-extrusion line;
(c) the above compositions so obtained were extruded using three co-extrusion line (Extruder A,B,C) and a homogenous extrudate was formed;
(d) slip and anti-block additives were added to the compositions that were suitable for forming the skin layers in the Extruder A and Extruder C;
(e) the extrudate so obtained, was further processed using conventional screws and subsequently a melted polymer composition was formed by using a feed block;
(f) the melted polymer composition was conveyed to a die head section using different types of annular dies and a film precursor was formed; and
(g) the film precursor was thereafter cooled to form the multilayer film.

Specifically, the extruding conditions that were used is summarized as follows:

TABLE 3
Extruder Processing Conditions

| | Screw | Melt | Melt |
|---|---|---|---|
| | Speed | Pressure | Temperature |
| | (rpm) | (bar) | (° C.) |
| Extruder A (First Skin Layer) | 7 | ~104 | ~200 |
| Extruder B (Core Layer) | 43 | ~140 | ~215 |
| Extruder C (Second Skin Layer) | 7 | ~176 | ~201 |

TABLE 4
Extruder Temperature (° C.)

| | Extruder A | Extruder B | Extruder C |
|---|---|---|---|
| | (° C.) | (° C.) | (° C.) |
| Temperature Zone 1 | 40-190 | 40-200 | 40-190 |
| Temperature Zone 2 | 195-200 | 210 | 195-200 |
| Temperature Zone 3 | 210 | 210 | 210 |

TABLE 5
Extrusion specification and processing

| Die diameter | Die Gap | Output | Air ring |
|---|---|---|---|
| 200 mm | 2.5 | 41 kg/h | 34% |

To evaluate the films, the following test protocols were used:

Melting temperature of constituent polymers: The melting temperature of the ethylene polymer, the first ethylene alpha-olefin copolymer, and the second ethylene alpha-olefin copolymer were determined using Differential Scanning Calorimetry (DSC) in accordance with the procedure outlined in ASTM D3418-15 and is as set forth below:
a film sample having a mass of 10 mg was used by first weighing the sample in a balance having accuracy of ±0.01 mg;
the cell of the DSC was purged using nitrogen gas at a flow rate of 50±5 mL/min, and the sample and empty reference pan of same size, shape and material was placed at their respective positions;
thereafter, the sample was equilibrated at 23° C. for 1 min and subsequently heated to a temperature of 200° C., at the rate of 10° C./min and a first heating curve was recorded, and at 200° C., the heating was maintained for 2 minutes; and
thereafter, the sample was cooled at the rate of 10° C./min, and the cooling curve was noted, and the steps were repeated to record the second heating curve.

Melting temperature of multilayer film: The melting temperature of the multilayer film was determined by coupling a isothermal hot stage analysis with optical microscopy under conditions of temperature typically used in compounding rubber/polymer material in accordance with the process steps outlined under ISO17025 (2017). A film sample of ˜1.5 mm×1.5 mm was used for the analysis. The sample was placed on 1.5 cm diameter circular glass slides. The sample was covered with identical glass slides and examined using a hot stage light microscope (Leica DMRXP research light microscope fitted with Linkam THMS600 heating stage). The sample was heated to 85° C. thereafter isothermally maintained at 85° C. for 3 minutes and an image of the film sample was recorded. Subsequently, the film sample was heated to 90° C. and isothermally maintained at that temperature for 3 minutes and an image of the film sample was recorded at 90° C. The identical steps were repeated for each temperature of 95° C., 100° C., 105° C., 110° C., 150° C. and image of the film samples at that specific temperature were recorded.

Elastic modulus, tensile elongation (TE) at yield and tensile strength at yield: were determined in accordance with the procedure outlined under ASTM D882.

Tear Resistance: The tear resistance was determined in accordance with the procedure outlined under ASTM D1922.

Multilayer Film samples: The following set of film structure was analyzed:

The inventive film one (IF1) has the following distribution of polymers as shown in the table below:

TABLE 6
Inventive Film (IF1)

| | | First | Second | | | | |
|---|---|---|---|---|---|---|---|
| | | Ethylene- | Ethylene- | | | | |
| | | alpha | alpha | | | | |
| | Ethylene | olefin co- | olefin co- | | AB | | |
| | polymer | polymer | polymer | Slip MB | Masterbatch | Layer | Thickness |
| Film Layer | (wt. %) | (wt. %) | (wt. %) | (wt. %) | (wt. %) | distribution | μm |
| First skin layer | 40 | 57 | 0 | 1.5 | 1.5 | 15% | 27 |
| Core layer | 20 | 50 | 30 | 0 | 0 | 70% | 126 |
| Second skin | 40 | 57 | 0 | 1.5 | 1.5 | 15% | 27 |
| layer | | | | | | | |
| Overall wt. % | 26 | 52.1 | 21 | 0.45 | 0.45 | 100 | 180 |

The inventive film two (IF2) has the following distribution of polymers as shown in the table below:

TABLE 7
Inventive Film (IF2)

| | | First | Second | | | | |
|---|---|---|---|---|---|---|---|
| | | Ethylene- | Ethylene- | | | | |
| | | alpha | alpha | | | | |
| | Ethylene | olefin co- | olefin co- | | AB | | |
| | polymer | polymer | polymer | Slip MB | Masterbatch | Layer | Thickness |
| Wt. % | (wt. %) | (wt. %) | (wt. %) | (wt. %) | (wt. %) | distribution | μm |
| First skin layer | 37.5 | 59.5 | 0 | 1.5 | 1.5 | 15 | 27 |
| Core layer | 12.5 | 54.5 | 33 | 0 | 0 | 70 | 126 |
| Second skin | 37.5 | 59.5 | 0 | 1.5 | 1.5 | 15 | 27 |
| layer | | | | | | | |
| Overall wt. % | 20 | 56 | 23.1 | 0.45 | 0.45 | 100 | 180 |

The comparative film one (CF1) has the following distribution of polymers as shown in the table below:

TABLE 8
Comparative Film (CF1)

| | | First | Second | | | | |
|---|---|---|---|---|---|---|---|
| | | Ethylene- | Ethylene- | | | | |
| | | alpha | alpha | | | | |
| | Ethylene | olefin co- | olefin co- | | AB | | |
| | polymer | polymer | polymer | Slip MB | Masterbatch | Layer | Thickness |
| Film Layer | (wt. %) | (wt. %) | (wt. %) | (wt. %) | (wt. %) | distribution | μm |
| First skin layer | 25 | 71 | 0 | 2 | 2 | 11 | 15.4 |
| Core layer | 7 | 53 | 40 | 0 | 0 | 78 | 109.2 |
| Second skin | 25 | 71 | 0 | 2 | 2 | 11 | 15.4 |
| layer | | | | | | | |
| Overall wt. % | 10.96 | 57 | 31.2 | 0.4 | 0.4 | 100 | 140 |

The comparative film two (CF2) has the following distribution of polymers as shown in the table below:

TABLE 9
Comparative Film (CF2)

| | | First | Second | | | | |
|---|---|---|---|---|---|---|---|
| | | Ethylene- | Ethylene- | | | | |
| | | alpha | alpha | | | | |
| | Ethylene | olefin co- | olefin co- | | AB | | |
| | polymer | polymer | polymer | Slip MB | Masterbatch | Layer | Thickness |
| Film Layer | (wt. %) | (wt. %) | (wt. %) | (wt. %) | (wt. %) | distribution | μm |
| First skin layer | 25 | 71 | 0 | 2 | 2 | 11 | 15.4 |
| Core layer | 12.25 | 54.25 | 33.5 | 0 | 0 | 78 | 109.2 |
| Second skin | 25 | 71 | 0 | 2 | 2 | 11 | 15.4 |
| layer | | | | | | | |
| Overall wt. % | 15.055 | 57.9 | 26.1 | 0.04 | 0.04 | 100 | 140 |

The comparative film three (CF3) has the following distribution of polymers as shown in the table below. The film CF3 has a film architecture similar to that described in the PCT application PCT/EP2020/085419, which describes a film suitable for horizontal filling of rubber bales.

TABLE 10
Comparative Film (CF3)

| | | | Second | | | |
|---|---|---|---|---|---|---|
| | | First | Ethylene- | | | |
| | | Ethylene- | alpha | Slip | AB | |
| | Ethylene | alpha olefin | olefin co- | MB | Master- | Thick- |
| | polymer | co-polymer | polymer | (wt. | batch | ness |
| Film Layer | (wt. %) | (wt. %) | (wt. %) | %) | (wt. %) | μm |
| First Skin | 15 | 79 | 0 | 2 | 4 | 15.4 |
| Layer | | | | | | |
| Core Layer | 0 | 0 | 100 | 0 | 0 | 109.2 |
| Second Skin | 15 | 79 | 0 | 2 | 4 | 15.4 |
| Layer | | | | | | |

The comparative film four (CF4) is an ethylene vinyl acetate (EVA) based film and has the following distribution of polymers as shown in the table below:

TABLE 11
Comparative Film (CF4)

| | | EVA | | Slip Agent |
|---|---|---|---|---|
| | Thickness | content | | and Anti- |
| Film Layer | (140 μm) | wt. % | Plastomer | block agents |
| First skin Layer | 28 | 94 | 0 | 6 |
| Core Layer | 84 | 0 | 97.5 | 2.5 |
| Second Skin | 28 | 94 | 0 | 6 |
| Layer | | | | |

The results from the evaluation of the inventive film (IF1 and IF2) and the comparative films (CF1-CF4) are provided below:

TABLE 12
Property parameter results

| | IF1 | IF2 | CF1 | CF2 | CF3 | |
|---|---|---|---|---|---|---|
| | (26.6 | (20.0 | (10.96 | (15.05 | (3.0 | CF4 |
| | wt. % | wt. % | wt. % | wt. % | wt. % | (EVA |
| | LDPE) | LDPE) | LDPE) | LDPE) | LDPE) | based) |
| Elastic | 110.0 | 90.0 | ~30 | ~55.0 | ~26.0 | ~82 |
| Modulus | | | | | | |
| (MPa) | | | | | | |
| Melting | 104 | 103.5 | 93.3 | 95 | 85 | 93.9 |
| Temperature | | | | | | |
| (° C.) | | | | | | |
| Tear | 8.21 | 7.41 | NA | 5.75 | NA | 5.58 |
| Resistance | | | | | | |
| (MD) (g/μm) | | | | | | |
| Tensile | 54.0 | 48.4 | NA | 29.3 | 32 | 37.0 |
| Elongation | | | | | | |
| @Yield (MD) | | | | | | |
| (%) | | | | | | |
| Tensile | 7.7 | 7.05 | NA | 5.19 | 5.13 | 6.62 |
| Strength | | | | | | |
| @Yield (MD) | | | | | | |
| (MPa) (%) | | | | | | |

From the results as shown in the above table it is evident that the inventive films (IF1 and IF2) demonstrate a balance of desired melting temperature and elastic modulus over that of the comparative films (CF1-CF4). In particular, the combination of ethylene polymer, first ethylene alpha-olefin copolymer and the second ethylene alpha-olefin copolymer as shown in the inventive films IF1 and IF2, impart at least 63% higher elastic modulus over that of the comparative films (IF2 versus CF2) indicating that such films have the desired stiffness as required in a VFFS packaging line. Surprisingly, the films, IF1 and IF2, demonstrated a melting temperature suitable for compounding. From the optical microscopy analysis, no trace residue of the film was observed around the melting temperature of the film, resulting in rubber based products, which are free of “fish eye” defects.

In addition, the inventive films IF1 and IF2 demonstrated improved properties of stiffness over multilayer film CE3, which are typically used in horizontal form filling. In addition, the inventive films IF1 and IF2 demonstrate improved mechanical properties of tear resistance, tensile elongation and tensile strength over that of film CF4 (the EVA based). For example, tensile elongation of IF1 film is near 46% higher than that of CF4 film (EVA based film). Such favorable properties render the inventive film being durable for the packaging and transportation of products such as rubber pellets, or food and beverage items.

1. A multilayer film, comprising:
a first skin layer and a second skin layer, wherein each of the first skin layer and the second skin layer independently comprises:
≥30.0 wt. % and ≤45.0 wt. %, of an ethylene polymer, with regard to the total weight of the skin layer; wherein the ethylene polymer has a density ≥918 kg/m³ and ≤940 kg/m³, when determined in accordance with ASTM D792 (2008);
≥55.0 wt. % and ≤70.0 wt. %, of a first ethylene alpha-olefin copolymer; wherein the first ethylene alpha-olefin copolymer has a density >900 kg/m³ and ≤915 kg/m³, as determined in accordance with ASTM D792 (2008); and
a core layer, positioned between the first skin layer and the second skin layer, wherein the core layer comprises:
≥5.0 wt. % and ≤25.0 wt. %, of the ethylene polymer, with regard to the total weight of the core layer;
≥25.0 wt. % and ≤70.0 wt. %, of the first ethylene alpha-olefin copolymer, with regard to the total weight of the core layer; and
≥25.0 wt. % and ≤50.0 wt. %, of a second ethylene alpha-olefin copolymer; wherein the second ethylene alpha-olefin copolymer has a density ≥850 kg/m³ and ≤900 kg/m³, as determined in accordance with ASTM D792 (2008).

2. The multilayer film according to claim 1, wherein the multilayer film comprises:
≥16.0 wt. % and ≤30.0 wt. %, of the ethylene polymer, with regard to the total weight of the multilayer film;
≥50.0 wt. % and ≤70.0 wt. %, of the first ethylene alpha-olefin copolymer, with regard to the total weight of the multilayer film; and/or
≥14.0 wt. % and ≤25.0 wt. %, of the second ethylene alpha-olefin copolymer, with regard to the total weight of the multilayer film.

3. The multilayer film according to claim 1, wherein:
the first ethylene alpha-olefin copolymer comprises moieties derived from (i) ethylene and (ii) ≥2.0 wt. % and ≤25.0 wt. %, of moieties derived from one or more alpha-olefins having 3-12 carbon atoms, with regard to the total weight of the first ethylene alpha-olefin copolymer; and/or
the second ethylene alpha-olefin copolymer comprises moieties derived from (i) ethylene and (ii) ≥30.0 wt. % and ≤45.0 wt. %, of moieties derived from one or more alpha-olefins having 3-12 carbon atoms, with regard to the total weight of the second ethylene alpha-olefin copolymer.

4. The multilayer film according to claim 1, wherein the one or more alpha-olefin having 3-12 carbon atoms is selected from 1-butene, 4-methyl-1-pentene, 1-hexene, and 1-octene.

5. The multilayer film according to claim 1, wherein each of the first skin layer and/or the second skin layer independently further comprises one or more additives, present in an amount ≥1.0 wt. % and ≤6.0 wt. %, with regard to the total weight of each skin layer.

6. The multilayer film according to claim 1, wherein the core layer is present in an amount ≥65.0 wt. % and ≤80.0 wt. %, with regard to the total weight of the multilayer film.

7. The multilayer film according to claim 1, wherein each of first skin layer and the second skin layer is present independently in an amount ≥5.0 wt. % and ≤20.0 wt. %, with regard to the total weight of the multilayer film.

8. The multilayer film according to claim 1, wherein the ethylene polymer has at least:
a melt flow rate (MFR) of ≥0.1 g/10 min and ≤5.0 g/10 min, as determined at 190° C. at 2.16 kg load in accordance with ASTM D1238; and/or
a melting temperature ≥105° C. and ≤125° C., when determined in accordance with a method based on ASTM D3418-15, using Differential Scanning Calorimetry (DSC) with a first heating and cooling cycle at a temperature between 23° C. to 200° C. and at a heating and a cooling rate of 10° C./min for a 10 mg film sample, using a nitrogen purge gas at flow rate of 50±5 mL/min, followed by a second heating cycle identical to the first heating cycle.

9. The multilayer film according to claim 1, wherein the first ethylene alpha-olefin copolymer has at least any one of:
a melting temperature of ≥85° C. and ≤115° C., using Differential Scanning Calorimetry (DSC) with a first heating and cooling cycle at a temperature between 23° C. to 200° C. and at a heating and a cooling rate of 10°° C./min for a 10 mg film sample, using a nitrogen purge gas at flow rate of 50±5 mL/min, followed by a second heating cycle identical to the first heating cycle; and/or
a melt flow rate ≥0.1 g/10 min and ≤5.0 g/10 min, when determined at 190° C. at 2.16 kg load in accordance with ASTM D1238.

10. The multilayer film according to claim 1, wherein the second ethylene alpha-olefin copolymer has at least one of:
a melting temperature ≥60° C. and ≤85° C., using Differential Scanning Calorimetry (DSC) with a first heating and cooling cycle at a temperature between 23° C. to 200° C. and at a heating and a cooling rate of 10° C./min for a 10 mg film sample, using a nitrogen purge gas at flow rate of 50±5 mL/min, followed by a second heating cycle identical to the first heating cycle; and/or
a melt flow rate ≥0.1 g/10 min and ≤3.0 g/10 min, when determined at 190° C. at 2.16 kg load in accordance with ASTM D1238.

11. The multilayer film according to claim 1, wherein the multilayer film has:
an elastic modulus of ≥82.0 MPa and ≤150.0 MPa, as determined in accordance with ASTM D882; and/or
a melting temperature ≥70° C. and ≤110° C., when determined using isothermal hot stage analysis with optical microscopy in accordance with ISO 17025 (2017), using a temperature sweep between ≥85° C. and ≤150° C. and analyzed at each temperature for three minutes and at a heating and a cooling rate of 10° C./min; and/or
a tear resistance in the machine direction (MD) of ≥6.0 g/μm and ≤15.0 g/μm, when determined in accordance with ASTM D1922; and/or
a tensile elongation at yield in the machine direction (MD) of ≥40.0% and ≤70.0%, as determined in accordance with ASTM D882.

12. The multilayer film according to claim 1, wherein the multilayer film has a thickness of ≥70 μm and ≤200 μm.

13. An article comprising the multilayer film according to claim 1, wherein the article is selected from a packaging bag, an agricultural film, or a shrink film, preferably the article is a packaging bag for vertical form filling and sealing packaging line for rubber pellets.

14. A process for producing a packaged material in a vertical form filling and sealing line, wherein the process comprises the steps in this order of:
providing a packaging bag comprising the multilayer film according to claim 1, wherein the packaging bag has a sealed end and an open end such that the longitudinal axis of the bag passes axially through the sealed end and the open end;
clamping the packaging bag at the sealed end, wherein the open end and the close end is co-axial with the longitudinal axis;
introducing a material for packaging into the packaging bag by means of the open end until at least a portion of the packaging bag is filled;
sealing the open end of the packaging bag; and
detaching the clamp and obtaining the packaged material.

15. (canceled)
